(19) United States
(12) Patent Application Publication
(10) Pub. No.: US 2021/0327016 A1
(43) Pub. Date: Oct. 21, 2021

(54) Modifying an Attribute of a Gaming Machine Based on Fantasy Sports

(71) Applicant: Pen-Tech Associates, Inc., Kennesaw, GA (US)

(72) Inventors: Ray Heim, Marietta, GA (US); John Jimenez, Powder Springs, GA (US); Gregory Graham, Moneta, VA (US); L. Dwayne Graham, Powder Springs, GA (US)

(73) Assignee: Pen-Tech Associates, Inc., Kennesaw, GA (US)

(21) Appl. No.: 17/235,001

(22) Filed: Apr. 20, 2021

Related U.S. Application Data
(60) Provisional application No. 63/012,355, filed on Apr. 20, 2020.

(51) Int. Cl. G06Q 50/34; G07F 17/32; G06F 16/2457

(52) U.S. Cl. CPC G06Q 50/34; G06F 16/2457; G07F 17/3244; G07F 17/3288

(57) ABSTRACT

Systems and methods are provided for modifying an attribute of a casino gaming system. A fantasy sport competition may be played on the machine and the outcome of the competition determines whether an attribute of the machine will be modified. The competition may be between participant playing at different machines or it may be a sole participant playing at a single machine.

### CROSS REFERENCE TO RELATED APPLICATIONS

This application claims the benefit of the filing date of U.S. provisional patent application No. 63/012,355 entitled “Modifying an Attribute of a Gaming Machine Based on Fantasy Sports”, which was filed on Apr. 20, 2020, by the same inventors as this application. That provisional application is hereby incorporated by reference as if fully set forth herein.

### FIELD OF THE TECHNOLOGY

The technology of this application relates generally to casino gaming machines, often referred to as slot machines, and more particularly but not exclusively to modifying an attribute of the machine based on a fantasy matchup between athletes (college, professional and/or animals).

### BACKGROUND OF THE TECHNOLOGY

Casino gaming machines, such as video poker, reels, bingo, etc., as opposed to table games such as craps, black jack, Pai Gow, etc. are designed by law to return/payout a certain average percentage of the money that they take in. For example, slot machines in New Jersey must be set to pay back a minimum of 83%, while machines in Nevada have a lower limit of 75%.

Gamblers are always looking for an “edge”—a way to make their odds of winning greater. For example, slot players are always looking for “loose” machines (e.g. machines that have the best payout percentage). However, the actual payout of a machine is not typically known to a player. Additionally, gamblers, by their nature, take risks that they think may benefit them—even if there is the possibility that the risk will be detrimental. Thus, if a gambler sees an opportunity to change the odds of winning at a machine, they are more likely to play that machine.

It may be advantageous to create systems and methods for enabling a gambler to modify an attribute of a slot machine.

### BRIEF SUMMARY OF THE TECHNOLOGY

Many advantages will be determined and are attained by one or more embodiments of the technology, which in a broad sense provides systems and methods for modifying one or more attributes of a gaming machine based at least in part on the results of a fantasy sport competition.

One or more embodiments of the technology provide(s) method for modifying one or more attributes of a gaming machine. The modification may be based on a fantasy sport competition played on the machine or played between/amongst multiple machines. In one or more embodiments, there may be the option to modify multiple attributes of the machine. A participant may select a sport, team and/or athlete and the machine selects one or more criteria for the athlete. The criteria are compared to a set of statistics to generate a score/value for each selected athlete. If multiple athletes are selected, the score may be a sum of the scores for each athlete or an average. Based at least in part on the final score being greater than a threshold and/or another participant's score, the one or more attributes may be modified.

One or more embodiments of the technology provide(s) a method for modifying one or more attributes of a gaming machine. The method may include the machine receiving as input a selection of at least one athlete. The method may further include the machine selecting at least one criterion related to the selected athlete and the machine obtaining a set of statistics associated with the selected athlete(s)/criterion. The machine may determine a value for the set of statistics associated with the athlete(s)/criterion and may change at least one attribute of the machine based at least in part on the determined value.

One or more embodiments of the technology provide(s) a non-transitory computer-readable medium which includes one or more computer-executable instructions that, when executed by at least one processor of a computing device, cause the computing device to receive as input a selection of at least one athlete. The instructions may further cause the computing device to select at least one criterion related to the selected athlete, obtain a set of statistics associated with the athlete(s)/criterion and determine a value for the set of statistics. The instructions may further cause the computing device to modify at least one attribute of the computing device based at least in part on the determined value.

One or more embodiments of the technology provide(s) a system for modifying an attribute of a gaming machine. The system may include a gaming machine having various attributes, a processor, a display, and an input device. The system also may include a database of statistics accessible by the gaming machine. The gaming machine may receive as input a selection of an athlete and in response to the selection of the athlete, the processor may select a criterion relevant to the athlete, access the database and receive statistics related to the selected criterion. The processor may further determine a value for the received statistics and based at least in part on the determined value modify at least one of the attributes.

The technology will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the technology, reference is made to the following description, taken in conjunction with any accompanying drawings in which:

FIG. 1 illustrates a block diagram of an exemplary system for modifying an attribute of a gaming machine in accordance with one or more embodiments of the disclosed technology;

FIG. 2 illustrates a block diagram providing elements present in the devices in the system of FIG. 1;

FIG. 3 illustrates exemplary screen shots of a game machine programmed in accordance with one or more embodiments of the disclosed technology;

FIG. 4 illustrates a flow chart for modifying an attribute of a gaming machine in accordance with one or more embodiments of the disclosed technology; and,

FIG. 5 illustrates a flow chart for one or more alternate embodiments for modifying an attribute of a gaming machine in accordance with one or more embodiments of the disclosed technology.

The technology will next be described in connection with certain illustrated embodiments and practices. However, it will be clear to those skilled in the art that various modifications, additions, and subtractions can be made without departing from the spirit or scope of the claims.

### DETAILED DESCRIPTION OF THE TECHNOLOGY

One or more embodiments of the technology provides, in a broad sense, systems and methods for modifying an attribute of a casino gaming system. The participant may be provided an option to select a fantasy sport such as but not limited to baseball, basketball, football, soccer, hockey, rugby, horse racing, dog racing, car racing, etc. or the sport may be preset by the machine. The participant may also be provided an option to select one or more players, teams, and/or portions of a team such as a defense. Once the sport and the athlete/team/team portion is selected, the system may select one or more criteria related to the participant's pick(s), such as but not limited to rushing touchdowns, passing touchdowns, yards-per-carry, yards-after-catch, runs batted in (rbi's), earned run average (era), stolen bases, triple doubles, hat tricks, goals or any other statistic related to the selection. The criteria may be randomly selected by the system and/or one or more criteria may be selected by the participant from a randomly or a preselected group of criteria provided by the system. Alternatively, the criteria and the athlete/team/team portion may be switched such that the participant initially selects the criteria and the system selects the athlete/team/team portion. Once the sport, athlete/team/team portion and criteria are selected, the system may compare the selections to a database of historical statistics related to the selections. The comparison may be randomly selected from a historical period such as a season, multiple seasons, a game, multiple games, a race, multiple races and/or it could be played in real-time such that the statistics are developing based on a real-time event such as a presently occurring game or race. The results of the comparison may be employed by the system to modify an attribute of the game such as the average payout percentage of the machine, the number of lines or reels available for play, the available jackpot that the participant may be eligible for, the availability of bonus rounds, etc.

Discussion of an embodiment, one or more embodiments, an aspect, one or more aspects, a feature, one or more features, a configuration or one or more configurations, or an instance or one or more instances is intended be inclusive of both the singular and the plural depending upon which provides the broadest scope without running afoul of the existing art and any such statement is in no way intended to be limiting in nature. Technology described in relation to one or more of these terms is not necessarily limited to use in that embodiment, aspect, feature, configuration or instance and may be employed with other embodiments, aspects, features, configurations and/or instances where appropriate.

For purposes of this disclosure “gaming machine” or “machine” shall mean any electronic game of chance. By way of a non-exhaustive list of examples, the machine may be a physical or online slot, video poker game, bingo game, any Class II or Class III game, an electronic pull-tab game, etc. It may be a personal computer, tablet, smart phone, stand-alone machine in a casino or other establishment.

For purposes of this disclosure “fantasy sports” shall mean a statistical representation of a professional or college level (or some other recognized and followed amateur level such as the Olympics etc.) sport or game may be included. By way of a non-exhaustive list of examples, baseball, basketball, football, soccer, track and field, hockey, rugby, horse racing, dog racing, car racing, motorcycle racing, boat racing, yacht racing, bowling, chess, cricket, tennis, golf, etc. For purposes of this disclosure, when used to refer to the general activity rather than a specific event, the terms “sport”, “sports”, “game” and “games” shall be used interchangeably.

For purposes of this disclosure “athlete” shall mean a person or animal who plays a college level or professional level (or another recognized and followed amateur level) sport or game (collectively a “sport”) such as but not limited to those delineated above and/or a group of players that make up a common position in such college/amateur level or professional level sport or game, such as but not limited to a defense.

For purposes of this disclosure “criterion” and/or “criteria” shall mean one or more statistics related to the athlete, such as but not limited to rushing touchdowns, passing touchdowns, yards-per-carry, yards-after-catch, runs batted in (rbi's), earned run average (era), stolen bases, triple-doubles, hat tricks, goals, strikes, first place finishes, second place finishes, third place finishes, point totals, etc.

For purposes of this disclosure “statistics” shall mean historical statistics related to an athlete during a time period and/or real-time statistics based on the athlete's participation in a game taking place in real-time. The “time period” shall mean any definitive time period such as but not limited to a game, a season, multiple games, multiple seasons, a race, multiple races, a year, multiple years, etc.

For purposes of this disclosure “attribute” shall mean one or more features provided by the gaming machine such as but not limited to average payout percentage, available games, available jackpots, available reels, available lines, number of spins, rules of the game (e.g. dealer sticks/hits on soft seventeen, or 2× or 3× odds on 2 and/or 12 in craps), available bonus rounds, etc.

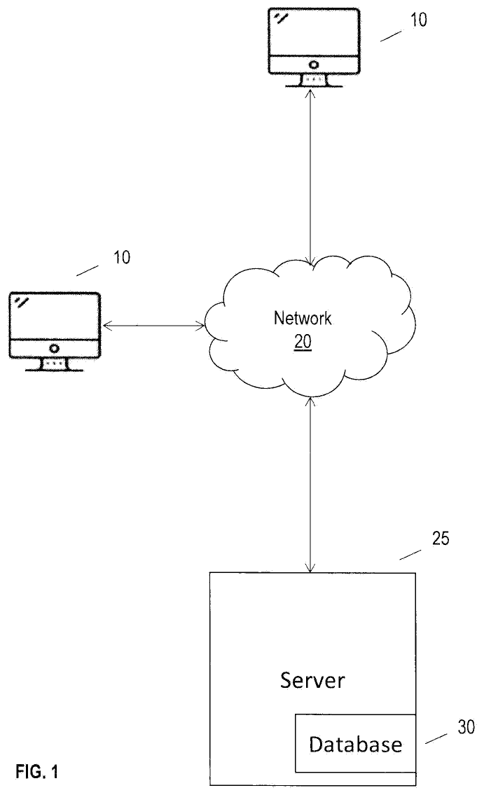

As illustrated in FIG. 1, the system may include one or more gaming machines 10 network(s) 20, server(s) 25 and database(s) of statistics 30. While it is anticipated that there may be one or more than one of each element, for ease of explanation the figure is limited to 2 gaming machines 10, 1 network 20, 1 server 25 and 1 database 30.

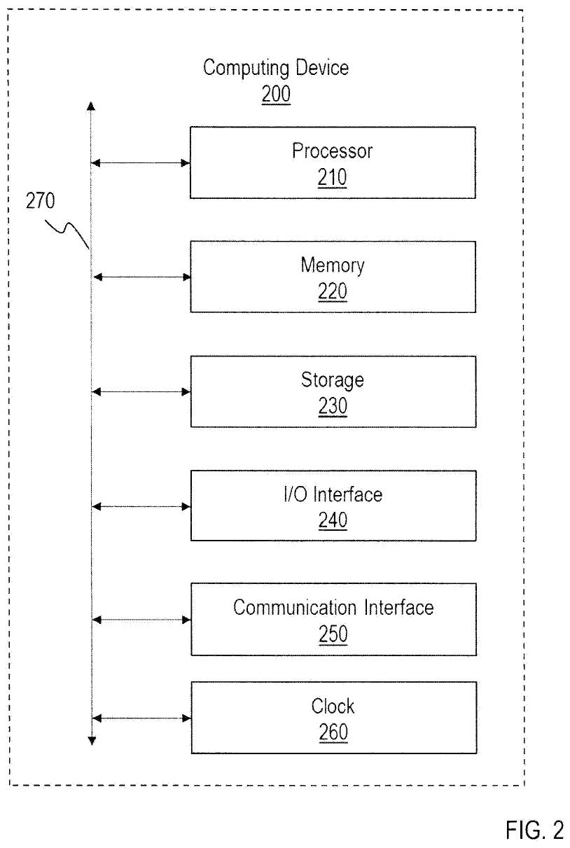

As illustrated in FIG. 1, each of the computing devices 10/20/25 may be implemented in any suitable computing system or group of computing systems to implement the techniques and methods disclosed herein. FIG. 2 is a block diagram depicting examples of implementations of such computing devices. The computing device 200 may include a processor 210 that is communicatively coupled to a memory 220 and that executes computer-executable program code and/or accesses information stored in memory 220 or storage 230. The processor 210 may include a microprocessor, an application-specific integrated circuit (“ASIC”), a state machine, or other processing device. The processor 210 may include one processing device or more than one processing device. Such a processor 210 may include or may be in communication with a computer-readable medium, which stores instructions that, when executed by the processor 210, cause the processor to perform the operations described herein.

The memory 220 and storage 230 may include any suitable non-transitory computer-readable medium. The computer-readable medium may include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 200 may also include external or internal devices such as input or output devices. For example, the computing device is shown with an input/output (“I/O”) interface 240 that can receive input from input devices or provide output to output devices. A communication interface 250 may also be included in the computing device 200 and may include any device or group of devices suitable for establishing a wired or wireless data connection to one or more data networks. Non-limiting examples of the communication interface 250 include an Ethernet network adapter, a modem, and/or the like. The computing device 200 may transmit messages as electronic or optical signals via the communication interface 250. The clock 260 is configured to identify time stamps for events. A bus 270 may also be included to communicatively couple one or more components of the computing device 200.

The computing device 200 may execute program code that configures the processor 210 to perform one or more of the operations described herein. The program code may include one or more modules. The program code may be resident in the memory 220, storage 230, or any suitable computer-readable medium and may be executed by the processor 210 or any other suitable processor. In one or more embodiments, modules may be resident in the memory 220. In additional or alternative embodiments, one or more modules may be resident in a memory that is accessible via a data network, such as a memory accessible to a cloud service.

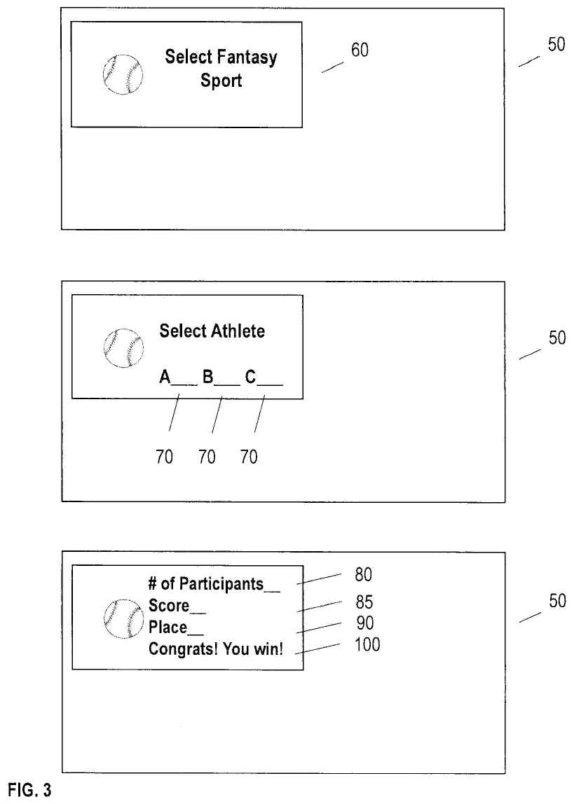

Gaming machines 30 may communicate with server 25 to access database 30. As illustrated in FIG. 3, the gaming machine includes a display 50 which may display an option to participate in a fantasy sport 60. The option may be provided at all times, or only after the participant purchases credits. The participant may be provided the option to select the sport from a dropdown menu, a scrolling list, or from any other applicable selection process. In one or more embodiments there may only be a single sport option. Subsequent to selecting the fantasy sport, the participant may be provided with a selection of available athletes 70. While 3 athletes 70 are displayed, this is merely for ease of explanation and the selection may be more or fewer than 3. Additionally, the selection may be a randomly generated subset of all athletes 70 from the selected fantasy sport or it may provide a preselected subset of all athletes 70 from the selected fantasy sport or it may provide every athlete 70 from the selected fantasy sport. The participant may be provided the option to select one or more athletes 70 and/or one or more sports and the number of athletes 70 and/or sports selected may be employed to increase or decrease the potential attribute modified. For example, a single athlete selection may only provide the possibility that the machine average payout percentage increases by 0.001% but a 4-athlete selection may provide the possibility that the machine average payout percentage increases by 1% or possibly a choice of different attributes to select from. Alternatively, to be eligible for an additional jackpot pool, the participant may need to select a minimum of 3 athletes, for example. These are merely examples for possible incentives to select more players. Many other possible incentives may be employed without departing from a scope of the claims.

Subsequent to the athlete selection, the machine 10 may contact server 25 for access to database 30. While database 30 is illustrated in server 25, in one or more embodiments all or some of the information from the database 30 may be stored locally (either temporarily or permanently). Either the machine 10 or the server 25, depending upon the design choice of the system, may randomly select the criteria to be employed with the selected athlete(s) and/or the statistics to employ for the fantasy contest. The criteria are then compared to the selected criteria and one or more values are assigned to the criteria. The total value of the criteria is then compared to a threshold and/or to values assigned to criteria of other participants. In one or more embodiments, the machine whose participant receives the highest value is awarded the modification. In one or more embodiments, the top x values are awarded modifications. In one or more embodiments, the value must be greater than the threshold for any machine 10 to receive the modification. In one or more embodiments values that reach or exceed the threshold, or a second threshold may be provided an additional or higher valued modification. While not preferred, in one or more embodiments the loser of a fantasy contest or a participant who doesn't reach a certain threshold (the same as discussed above or a different threshold) may have their machine modified in a negative manner.

FIG. 3 illustrates various exemplary screen shots of the fantasy sport contest. These contests may be played by participants who are playing the same game(s) on different machines, by participants who are playing different games on similar machines or by participants who are playing on machines that offer different games. The fantasy contest between participants may be based on the fantasy sport or they may be based on different fantasy sports selected by the participants. As illustrated, a participant may be provided with an option to select a fantasy sport 60. In one or more embodiments, this step may be skipped and the first option the participant may have is to select an athlete 70. Once the athlete 70 is selected the system may be configured to determine with which sport the athlete 70 is associated. Once all criteria are selected and compared with the database, the monitor may display one or more of the number of participants, the ranking out of the number of participants and/or the attribute(s) that has/have been modified. In one or more embodiments, if a participant wins the competition, the participant may be provided a selection of available attribute modifications.

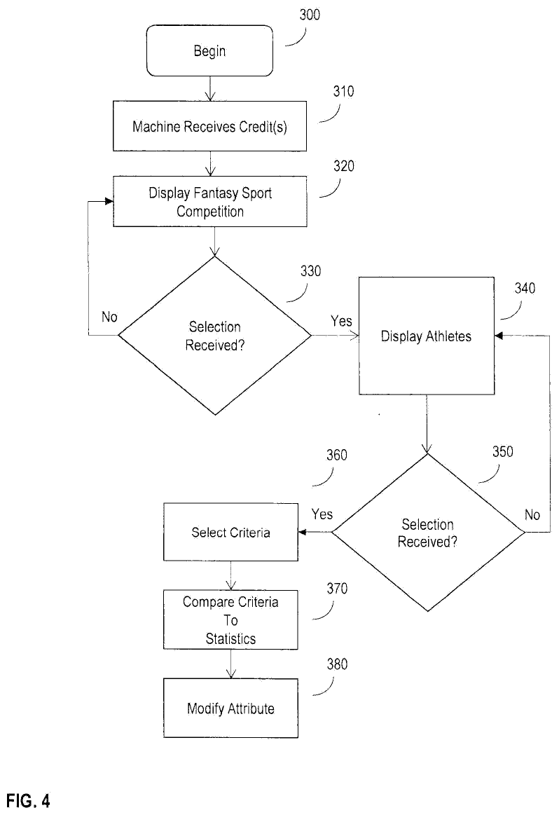

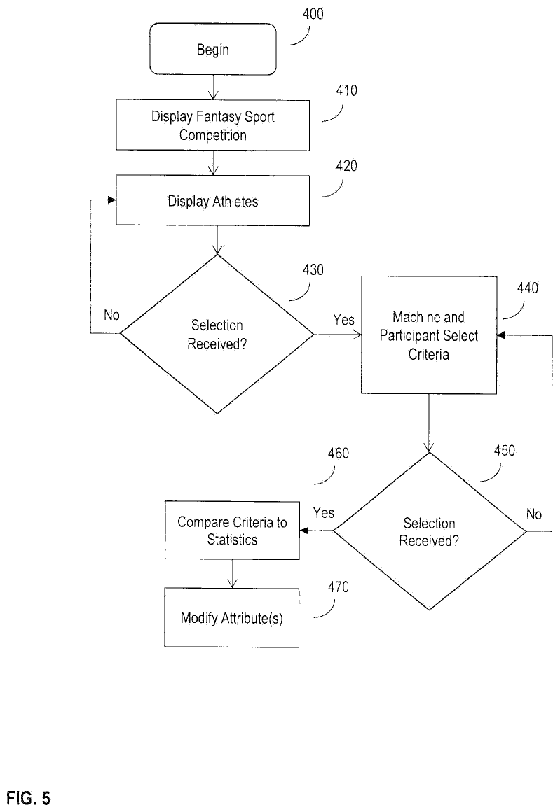

FIGS. 4 and 5 illustrate flow charts of alternate embodiments of the technology. As illustrated, in operation the system begins at step 300. At step 310, a participant enters credits 310 into the machine. A portion of the entered credits 310 may be applied towards participation in the fantasy sports competition or an additional amount of credit may be required for participation in the fantasy sport competition. In one or more embodiments, one or more of the steps may begin prior to the participant entering credits 310 such as cash, a voucher, a credit card, debit card, free spins, or any other method for obtaining credits to play the game or games offered by the machine. At step 320 the machine displays a fantasy sport selection 320. In one or more embodiments (e.g. FIG. 4), this step may be skipped or may be provided after the participant selects one or more athletes 340. In an embodiment in which the participant is required to select a fantasy sport as an initial selection, the machine determines if the selection has been made 330. If no selection has been made the machine continues to display the fantasy sport selection screen 320. In one or more embodiments in which additional credit is required to participate in the fantasy sports competition and the additional credit is not received, the machine may remove the display of the fantasy sport selection screen 320 after a preset or random time and/or the player may be provided an option for closing the fantasy sport selection screen 320. Once the fantasy selection is received by the machine 330 the machine displays a selection of athletes 340 from the selected fantasy sport. Depending on the design of the system, the selection may be limited to a subgroup of athletes or it may include all athletes. The selection may be limited to a certain number of selections or the selection may provide the participant with a choice of the number of athletes the participant wishes to select. Until the selection is received, the system may continue to display the athlete selection screen 340. Once the selection is received at 350, the system randomly selects criteria for the selected athletes 360. In one or more embodiments, all criteria are randomly selected. In one or more embodiments (e.g. FIG. 4), at least one criterion is randomly selected and at least one criterion is selected by the participant. In one or more embodiments, the criteria are selected by the participant and in one or more embodiments, the participant is provided a choice of how many criteria to employ. Once the criteria are selected the system randomly selects the statistics to employ for the fantasy sport contest 370. In one or more embodiments, the statistics may be selected after the fantasy sport selection or after the athlete selection or prior to offering the competition. At step 380 the criteria are compared with the statistics and a value is associated with the various criteria. The results are then compared at 390 to a threshold value, and/or the results for at least one other participant playing at another machine and/or to a second threshold value and the results of the comparison are employed to determine which machine if any has one or more attributes modified as a result of the fantasy competition. In one or more embodiments, a winning participant may be provided a selection of one or more attributes to modify. This selection may have been made at an earlier step or it may be provided only if a participant's performance qualifies for different attribute modifications. In one or more embodiments during one or more of the selection steps, the participant may be provided with a set amount of time for making a selection, after which time the participant may be withdrawn from participating in that particular competition or may have a default selection assigned.

Having thus described one or more embodiments of the technology, advantages can be appreciated. Variations from the described embodiments exist without departing from a scope of the following claims. It is seen that systems and methods are provided for modifying an attribute of a gaming machine based on a fantasy sport competition. Although embodiments have been disclosed herein in detail, this has been done for purposes of illustration only, and is not intended to be limiting with respect to the scope of the claims, which follow. It is contemplated by the inventors that various substitutions, alterations, and modifications may be made without departing from the spirit and scope of the technology as defined by the claims. Other aspects, advantages, and modifications are considered to be within the scope of the following claims. The claims presented are representative of the technology disclosed herein. Other, unclaimed technology is also contemplated. The inventors reserve the right to pursue such technology in later claims.

Insofar as embodiments described above are implemented, at least in part, using a computer system, it will be appreciated that a computer program for implementing at least part of the described methods and/or the described systems is envisaged as an aspect of the technology. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the technology as described herein, and all statements of the scope of the technology which, as a matter of language, might be said to fall there between.

Having described the technology, what is claimed as new and secured by Letters Patent is:

1. A method for modifying an attribute of a gaming machine, the method comprising:
the machine receiving as input a selection of at least one athlete;
the machine selecting at least one criterion related to the selected athlete;
the machine obtaining a set of statistics associated with the selected at least one athlete and the at least one criterion;
the machine determining a value for the set of statistics associated with the selected at least one athlete and the at least one criterion; and,
the machine changing at least one attribute of the machine based at least in part on the determined value.

2. The method according to claim 1 wherein the selection of the at least one criterion is a random selection.

3. The method according to claim 1 further including the machine receiving a selection of a sport.

4. The method according to claim 1 further including the machine receiving as input a selection of at least another criterion, the machine obtaining a set of statistics associated with the selected at least one athlete and the selected at least another criterion;
the machine determining another value for the selected at least one athlete and the selected at least another criterion; and
the machine changing at least another attribute based at least in part on the determined another value.

5. The method according to claim 4 wherein the at least one attribute and the at least another attribute are the same attribute.

6. The method according to claim 1 wherein obtaining the set of statistics includes communicating with a server via a network and receiving the set of statistics from a database on the server.

7. The method according to claim 1 further including the machine comparing the determined value to a threshold value and wherein the changing the at least one attribute of the machine is based at least in part on the comparison of the determined value and the threshold value.

8. The method according to claim 7 further including the machine changing a plurality of attributes based at least in part on the comparison of the determined value and the threshold value.

9. The method according to claim 1 further including another gaming machine,
the another machine receiving as input a selection of at least another athlete;
the another machine selecting at least one criterion related to the at least another athlete;
the another machine obtaining a set of statistics associated with the at least another athlete and the at least one criterion related to the at least another athlete;
the another machine determining another value for the set of statistics associated with the at least another athlete and the at least one criterion related to the at least another athlete;
wherein, when a comparison between the determined value and the determined another value result in the determined value being higher than the determined another value the machine changing the at least one attribute of the machine based at least in part on the comparison between the determined value and the determined another value; and,
wherein, when the comparison between the determined value and the determined another value result in the determined another value being higher than the determined value the another machine changing the at least one attribute of the another machine based at least in part on the comparison between the determined value and the determined another value.

10. A non-transitory computer-readable medium comprising one or more computer-executable instructions that, when executed by at least one processor of a computing device, cause the computing device to:
receive as input a selection of at least one athlete;
select at least one criterion related to the selected athlete;
obtain a set of statistics associated with the selected at least one athlete and the at least one criterion;
determine a value for the set of statistics associated with the selected at least one athlete and the at least one criterion; and,
modify at least one attribute of the computing device based at least in part on the determined value.

11. The non-transitory computer-readable medium according to claim 10 further comprising one or more computer-executable instructions that cause the computing device to receive a selection of a sport.

12. The non-transitory computer-readable medium according to claim 10 further comprising one or more computer-executable instructions that cause the computing device to:
receive as input a selection of at least another criterion;
obtain a set of statistics associated with the selected at least one athlete and the selected at least another criterion;
determine another value for the selected at least one athlete and the selected at least another criterion; and
change at least another attribute based at least in part on the determined another value.

13. The non-transitory computer-readable medium according to claim 10 wherein the at least one attribute and the at least another attribute are the same attribute.

14. The non-transitory computer-readable medium according to claim 10 further comprising one or more computer-executable instructions that cause the computing device to:
communicate with a server via a network and receiving the set of statistics from a database on the server.

15. The non-transitory computer-readable medium according to claim 10 further comprising one or more computer-executable instructions that cause the computing device to:
compare the determined value to a threshold value and change the at least one attribute of the computing device based at least in part on the comparison of the determined value and the threshold value.

16. The non-transitory computer-readable medium according to claim 15 further comprising one or more computer-executable instructions that cause the computing device to:
change a plurality of attributes based at least in part on the comparison of the determined value and the threshold value.

17. The non-transitory computer-readable medium according to claim 10 further comprising:
another non-transitory computer-readable medium comprising one or more computer-executable instructions that cause another computing device to receive as input a selection of at least another athlete;
select at least one criterion related to the at least another athlete;
obtain a set of statistics associated with the at least another athlete and the at least one criterion related to the at least another athlete;
determine another value for the set of statistics associated with the at least another athlete and the at least one criterion related to the at least another athlete;
wherein when a comparison between the determined value and the determined another value result in the determined value being higher than the determined another value the one or more computer-executable instructions cause the computing device to change the at least one attribute of the computing device at least in part on the comparison between the determined value and the determined another value; and,
wherein when the comparison between the determined value and the determined another value result in the determined another value being higher than the determined value the one or more computer-executable instructions cause the another computing device to change the at least one attribute of the another computing device based at least in part on the comparison between the determined value and the determined another value.

18. A system for modifying an attribute of a gaming machine, the system comprising:
a gaming machine having a plurality of attributes, a processor, a display, and an input device; and,
a database of statistics accessible by the gaming machine;
wherein the gaming machine receives as input a selection of an athlete;
wherein in response to the selection of the athlete, the processor selects a criterion relevant to the athlete, accesses the database and receives statistics related to the selected criterion, determines a value for the received statistics and based at least in part on the determined value modifies at least one of the plurality of attributes.

19. The system according to claim 18 further comprising a server and a network,
wherein the gaming machine is communicatively connected to the server via the network and the database is located on the server.

20. The system according to claim 18 wherein the gaming machine receives as input a selection of a plurality of athletes;
wherein the processor respectively selects criterion relevant to each of the plurality of athletes, accesses the database and receives statistics related respectively to the selected criterion, determines a combined value for the plurality of received statistics and based at least in part on the determined combined value modifies at least one of the plurality of attributes.

21. The system according to claim 18 wherein the processor modifies a plurality of attributes.

22. The system according to claim 18 wherein the system includes a plurality of gaming machines communicatively connected via a network;
wherein each of the plurality of gaming machines respectively has a plurality of attributes, a processor, a display, and an input device; and,
wherein at least another of the plurality of gaming machines receives as input a selection of another athlete;
wherein in response to the selection of the another athlete, the processor in the at least another of the plurality of gaming machines selects another criterion relevant to the another athlete, accesses the database and receives statistics related to the selected another criterion, determines a value for the received statistics related to the selected another criterion.

23. The system according to claim 22 wherein when a comparison between the determined value and the determined value for the received statistics related to the selected another criterion result in the determined value being higher than the determined value for the received statistics related to the selected another criterion the processor in the gaming machine changes the at least one attribute based at least in part on the comparison between the determined value and the determined value for the received statistics related to the selected another criterion; and, wherein when a comparison between the determined value and the determined value for the received statistics related to the selected another criterion result in the determined value being lower than the determined value for the received statistics related to the selected another criterion the processor in the at least another of the plurality of gaming machines changes the at least one attribute of the at least another of the plurality of gaming machines based at least in part on the comparison between the determined value and the determined value for the received statistics related to the selected another criterion.
